(19) United States
(12) Patent Application Publication
(10) Pub. No.: US 2010/0125906 A1
(43) Pub. Date: May 20, 2010

(54) RESETTING A FORGOTTEN PASSWORD USING THE PASSWORD ITSELF AS AUTHENTICATION

(75) Inventors: Philippe J.P. Golle, San Francisco, CA (US); Bjorn Markus Jakobsson, Mountain View, CA (US); Richard Chow, Sunnyvale, CA (US)

Correspondence Address: PVF -- PARC;c/o PARK, VAUGHAN & FLEMING LLP, 2820 FIFTH STREET, DAVIS, CA, 95618-7759, US

(73) Assignee: PALO ALTO RESEARCH CENTER INCORPORATED, Palo Alto, CA (US)

(21) Appl. No.: 12/273,789

(22) Filed: Nov. 19, 2008

(51) Int. Cl. H04L 9/32

(52) U.S. Cl. 726/18

(57) ABSTRACT

One embodiment of the present invention provides a system for resetting a user's forgotten password. During operation, the system receives a user's request for resetting the user's forgotten password and derives one or more challenges from the user's forgotten password. The system then presents the derived challenges to the user and receives a response from the user to the challenges. The system further compares the user's response to the one or more challenges with the user's forgotten password, thereby facilitating password resetting.

### BACKGROUND

1. Field of the Invention

The present disclosure relates to a method for resetting a user password. More specifically, the present disclosure relates to a method for resetting the user password using the password itself as authentication.

2. Related Art

The increased popularity of the Internet has changed modern life significantly. Many conventional activities have been transferred to the Internet. Internet users use the Internet to conduct daily activities such as shopping, banking, and social activities. For reasons of security and confidentiality, when using a web service, a user is often required by the web service to set up a password-protected account. In addition, in an enterprise environment, employees are often assigned password-protected user accounts to access emails and enterprise documents.

Once in a while a user may forget the password for his account and will need to retrieve his forgotten password or have his password reset. The password retrieving/resetting process can be cumbersome to users and costly to web services or enterprises.

Traditionally, to facilitate user authentication for password retrieving/resetting, a user is required to input answers to a set of personal questions while setting up a user account. The same questions can be later used to authenticate the user during password resetting. However, answers to these questions can sometimes be obtained by intruders. Some questions, such as the name of a pet, have easily guessable answers, while other questions, such as the name of the high school the user graduated from, have answers which can be obtained by searching the user's public record.

An improved approach is to require the user to input answers to a long list of questions related to personal preference when setting up an account. Such a requirement can be burdensome to the user. Another approach relies on the automatic collection of the information associated with the user by a web server or an enterprise server in order to authenticate the user. Such an approach can be expensive to the web service or enterprise.

### SUMMARY

One embodiment of the present invention provides a system for resetting a user's forgotten password. During operation, the system receives a user's request for resetting the user's forgotten password and derives one or more challenges from the user's forgotten password. The system then presents the derived challenges to the user and receives a response from the user to the challenges. The system further compares the user's response to the one or more challenges with the user's forgotten password, thereby facilitating password resetting.

In a variation on this embodiment, the one or more challenges include a plurality of strings which include the user's forgotten password, thereby allowing the user to recognize his password.

In a variation on this embodiment, presenting the one or more challenges comprises requesting the user to input a guess to the user's forgotten password, and comparing the user's response with the user's forgotten password includes calculating an edit distance between the guessed password and the user's forgotten password.

In a further variation, the systems iteratively, for a predetermined number of times, determines if the calculated edit distance is smaller than a predetermined threshold, and if so, the system allows the user to input a different guess to the user's forgotten password.

In a further variation, the guess to the user's forgotten password include a guess to a portion of the forgotten password.

In a further variation, calculating the edit distance includes applying using a weight function to each symbol in the guessed password.

### BRIEF DESCRIPTION OF THE FIGURES

FIG. 1 illustrates a flow chart for resetting a user password in accordance with one embodiment of the present invention.

FIG. 2 illustrates a flow chart for resetting a user's password by comparing the user's guess with the forgotten password in accordance with one embodiment of the present invention.

FIG. 3 illustrates a flow chart for resetting a user password in accordance with one embodiment of the present invention.

FIG. 4 illustrates an exemplary computer system for resetting a user password in accordance with one embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, volatile memory, non-volatile memory, application-specific integrated circuits (ASICs), field-programmable gate arrays (FPGAs), magnetic and optical storage devices such as disk drives, magnetic tape, CDs (compact discs), DVDs (digital versatile discs or digital video discs), or other media capable of storing computer-readable media now known or later developed.

### Generating Challenges Based on Forgotten Password

Embodiments of the present invention provide a method for resetting a user's forgotten password using the forgotten password as authentication.

Because most users choose a password in a non-random fashion, when a user forgets his password, most likely, he does not do so completely. A user may remember part of his password, or recall his password when presented with the password itself or a hint to the password.

Traditionally, a password hint is generated and saved by the user when the user sets up the account. When presented with the pre-saved hint, a user is expected to recall the forgotten password. However, users are often not able to generate good password hints. Some user-generated hints are not functional. When presented to the user, such hints give little information regarding the forgotten password. Some user-generated hints reveal too much information regarding the forgotten password, thus allowing an intruder to obtain the password by reading the password hint. For example, a user uses his birthday as a password and generates a hint saying “birthday.” Consequently, anyone who knows his birthday can guess his password by reading the hint.

To overcome the shortcomings of a user-generated password hint, in one embodiment, the web server or enterprise server generates a set of challenges, which are derived from the forgotten password but do not explicitly ask the user to input his forgotten password. Because the set of challenges are derived from the forgotten password, the server does not need to collect additional user information for password resetting.

Resetting Password by Selecting Correct Password against Decoys

A user may be able to recognize his forgotten password when presented with it. In one embodiment, after receiving a request for password resetting, the server presents the user with a set of possible passwords. The set of possible passwords contain the user's forgotten password and other decoy passwords. The system authenticates the user when he is able to recognize the correct password against all the decoys. For increased security, the number of decoy passwords can be substantially large. For example, the system can present the user 10 possible passwords including nine decoys.

To prevent an imposter from guessing the correct password among the decoys, in one embodiment, instead of presenting the whole password, the system can present portions of the password separately. For example, the system first presents the first four characters of the password along with other four-character decoy strings. If the user can recognize the first four characters of his password, the system presents the rest of the password along with other decoy strings for user selection.

In one embodiment, because the “true” password is presented to the user who requests the password resetting, to avoid security breaches, the user is requested to change the password once authenticated. Alternatively, if the requesting user does not recognize the correct password, the account is “locked” to block any future access attempts. Once a user account is locked, to unlock it, further authentication steps, such as calling the web service provider or the enterprise information help desk, are needed.

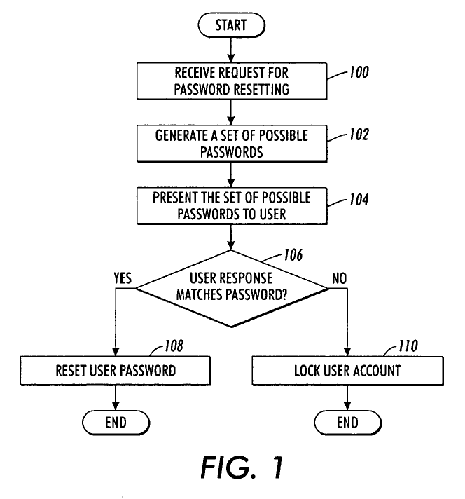

FIG. 1 illustrates a flow chart for resetting a password in accordance with one embodiment of the present invention. During operation, the server receives a request from a user for password resetting (operation 100). In response, the server generates a set of possible passwords, which includes the correct password and other decoys (operation 102). The server then presents the set of possible passwords to the user (operation 104). The user is required to select one password, which he thinks is the correct password based on his memory, from the set of possible passwords. Subsequently, the server compares the user's selection with the correct password (operation 106). If the user selects the correct password, the server authenticates the user and resets the user's password (operation 108). If the user selects one of the decoys, the server locks the user account (operation 110).

### Resetting Password by Allowing Repeated Guesses

Because most users hold a substantially large number of accounts and need to remember a large number of passwords, many users adopt an easily remembered password stem, and add variations to the stem to generate different passwords. Most likely, it is the variation, not the stem, which is forgotten by a user. Therefore, even when unable to recall the correct password, a user can still use the stem to get a close guess at the password.

In one embodiment, after requesting a password resetting, a user is allowed to submit a guessed password. If the guessed password closely resembles the true password, the user is authenticated. To measure how closely the guessed password resembles the true password, an edit distance, such as Hamming distance or Levenshtein distance, is calculated between the two password strings. If the edit distance between the guessed password and the true password is less than a predetermined threshold, the user is authenticated.

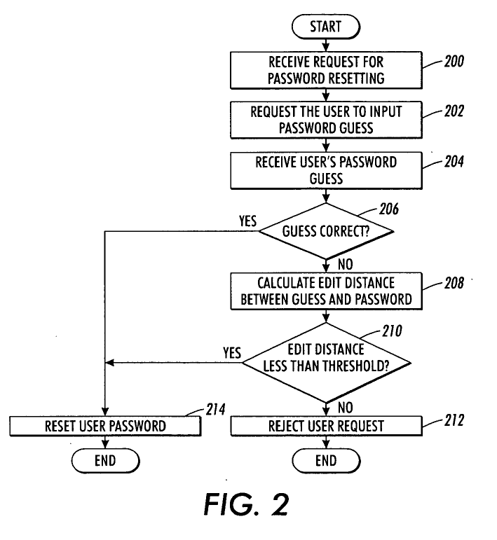

FIG. 2 illustrates a flow chart for resetting a user's password by comparing the user's guess with the forgotten password in accordance with one embodiment of the present invention. During operation, the server receives a request from a user for password resetting (operation 200). In response, the server requests the user to input a guessed password (operation 202). Subsequently, the server receives the user's guessed password (operation 204) and compares the guessed password with the correct password (operation 206). If the user correctly guesses the password, the server authenticates the user and resets the user's password based on the user's request (operation 214). If the user's guess is incorrect, the server calculates the edit distance between the guessed password and the true password (operation 208). The server then compares the calculated edit distance with a predetermined threshold (operation 210). If the edit distance is smaller than the threshold, the server authenticates the user and resets the user's password based on the user's request (operation 214). Otherwise, the server rejects the user's request (operation 212).

Most web servers today give users three chances to input a correct password. If a user submits an incorrect password three times in a row, the user account will be locked from further access. However, if the user forgets what variation he uses with the password stem, he may need more than three tries to recollect the correct password. To facilitate a user's attempts to retrieve his password provided he still remembers part of his password, in one embodiment of the present invention, a user is given a number of chances to guess the correct password, provided each of his guesses is sufficiently close to the true password.

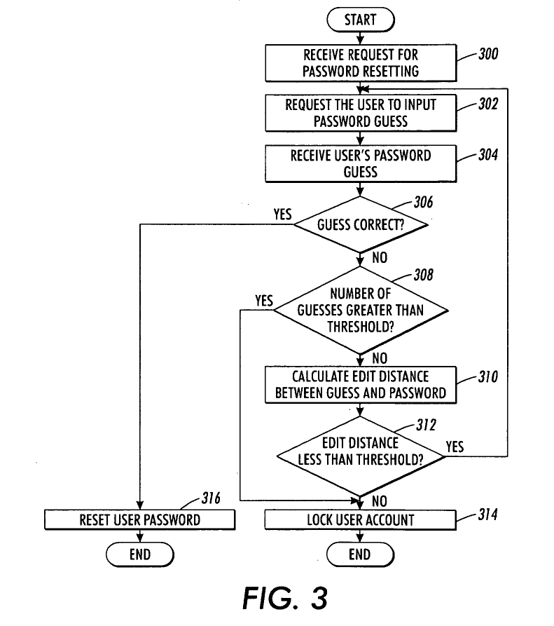

FIG. 3 illustrates a flow chart for resetting a user's password by allowing a number of guesses in accordance with one embodiment of the present invention. During operation, the server receives a request from a user for password resetting (operation 300). In response, the server requests the user to input a guessed password (operation 302). Subsequently, the server receives the user's guessed password (operation 304) and compares the guessed password with the true password (operation 306). If the user correctly guesses the password, the server authenticates the user and resets the user password (operation 316). If the user's guess is incorrect, the server determines if the number of guesses has exceeded a predetermined threshold number (operation 308). Note that the threshold number for allowed guesses can be a relatively large number. In one embodiment, a user is allowed 20 guesses. If the number of guesses has exceeded the threshold, the server locks the user account (operation 314). If the number of guesses is less than the threshold, the server calculates the edit distance between the guessed password and the true password (operation 3 10). The server then compares the calculated edit distance with a predetermined threshold (operation 312). If the edit distance between the guessed and true passwords is larger than the threshold, the server locks the user account (operation 314). Otherwise, the server allows the user to re-enter a password guess (operation 302). In a further embodiment, the system may forgive a user, a limited number of times, for making password guesses that have an edit distance larger than the threshold.

In one embodiment, for enhanced security, instead of guessing the whole password at once, a user can guess portions of the password separately. For example, a user may be required first to guess the beginning four characters of his password using the aforementioned method. After successfully guessing the beginning part of the password, the user is then required to guess the remainder of the password using the same technique. This approach decreases the odds for an intruder to correctly guess the user password.

In one embodiment, the server can apply a weight function to each symbol when calculating the edit distance between the guessed and correct passwords. Because users tend to remember letters better than numbers, in one embodiment, a number is given less weight than a letter when calculating the edit distance. In other words, the system tends to forgive more if a user forgets the correct number in his password.

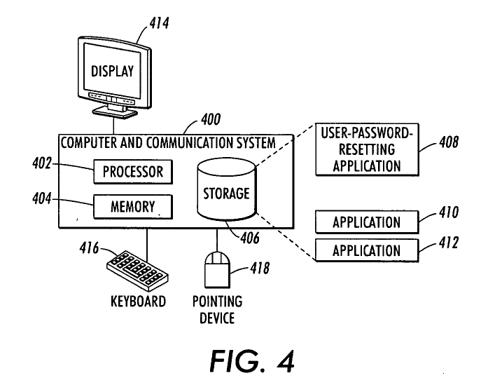

FIG. 4 illustrates an exemplary computer system for resetting user passwords in accordance with one embodiment of the present invention. In one embodiment, a computer and communication system 400 includes a processor 402, a memory 404, and a storage device 406. Storage device 406 stores a user-password-resetting application 408, as well as other applications, such as applications 410 and 412. During operation, user-password-resetting application 408 is loaded from storage device 406 into memory 404 and then executed by processor 402. While executing the program, processor 402 performs the aforementioned functions. Computer and communication system 300 is coupled to an optional display 414, keyboard 416, and pointing device 418. The display, keyboard, and pointing device can facilitate user password resetting.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method for resetting a user's forgotten password, the method comprising:
receiving a user's request for resetting the user's forgotten password;
deriving one or more challenges from the user's forgotten password;
presenting the derived challenges to the user;
receiving a response from the user to the challenges; and
comparing the user's response to the one or more challenges with the user's forgotten password, thereby facilitating password resetting.

2. The method of claim 1, wherein the one or more challenges comprise a plurality of strings which include at least part of the user's forgotten password, thereby allowing the user to recognize his password.

3. The method of claim 2, wherein the guess to the user's forgotten password includes a guess to a portion of the forgotten password

4. The method of claim 1, wherein presenting the one or more challenges comprises requesting the user to input a guess to the user's forgotten password, and wherein comparing the user's response with the user's forgotten password includes calculating an edit distance between the guessed password and the user's forgotten password.

5. The method of claim 4, further comprising:
iteratively, for a predetermined number of times, determining if the calculated edit distance is smaller than a predetermined threshold; and
if so,
allowing the user to input a different guess to the user's forgotten password.

6. The method of claim 4, wherein the guess to the user's forgotten password includes a guess to a portion of the forgotten password.

7. The method of claim 4, wherein calculating the edit distance comprises applying a weight function to each symbol in the guessed password.

8. A computer-readable storage medium storing instructions which when executed by a computer cause the computer to perform a method for resetting a user's forgotten password, the method comprising:
receiving a user's request for resetting the user's forgotten password;
deriving one or more challenges from the user's forgotten password;
presenting the derived challenges to the user;
receiving a response from the user to the challenges; and
comparing the user's response to the one or more challenges with the user's forgotten password, thereby facilitating password resetting.

9. The computer-readable storage medium of claim 8, wherein the one or more challenges comprise a plurality of strings which include at least part of the user's forgotten password, thereby allowing the user to recognize his password.

10. The computer-readable storage medium of claim 9, wherein the guess to the user's forgotten password includes a guess to a portion of the forgotten password.

11. The computer-readable storage medium of claim 8, wherein presenting the one or more challenges comprises requesting the user to input a guess to the user's forgotten password, and wherein comparing the user's response to the user's forgotten password includes calculating an edit distance between the guessed password and the user's forgotten password.

12. The computer-readable storage medium of claim 11, wherein the method further comprises:
iteratively for a predetermined number of times, determining if the calculated edit distance is smaller than a predetermined threshold; and
if so,
allowing the user to input a different guess to the user's forgotten password.

13. The computer-readable storage medium of claim 11, wherein the guess to the user's forgotten password includes a guess to a portion of the forgotten password.

14. The computer-readable storage medium of claim 11, wherein calculating the edit distance comprises applying a weight function to each symbol in the guessed password.

15. A computer system for resetting a user's forgotten password, comprising:
a processor;
a memory;
a first receiving mechanism configured to receive a user's request for resetting the user's forgotten password;
a challenge derivation mechanism configured to derive one or more challenges from the user's forgotten password;
a presentation mechanism configured to present the derived challenges to the user;
a second receiving mechanism configured to receive a response from the user to the challenges; and
a comparison mechanism configured to compare the user's response to the one or more challenges with the user's forgotten password, thereby facilitating password resetting.

16. The computer system of claim 15, wherein the one or more challenges comprise a plurality of strings which include at least part of the user's forgotten password, thereby allowing the user to recognize his password.

17. The computer system of claim 16, wherein the guess to the user's forgotten password includes a guess to a portion of the forgotten password.

18. The computer system of claim 15, wherein presenting the one or more challenges comprises requesting the user to input a guess to the user's forgotten password, and wherein comparing the user's response to the user's forgotten password includes calculating an edit distance between the guessed password and the user's forgotten password.

19. The computer system of claim 18, wherein the comparing mechanism is further configured to:
iteratively for a predetermined number of times, determine if the calculated string distance is smaller than a predetermined threshold; and
if so,
allowing the user to input a different guess to the user's forgotten password.

20. The computer system of claim 18, wherein the guess to the user's forgotten password includes a guess to a portion of the forgotten password.

21. The computer system of claim 18, wherein calculating the edit distance comprises applying a weight function to each symbol in the guessed password.
